(19) United States
(12) Patent Application Publication
(10) Pub. No.: US 2004/0201812 A1
(43) Pub. Date: Oct. 14, 2004

(54) Structure of liquid crystal display

(76) Inventors: Hung-Jen Chu, Nantou (TW); Hui-Chung Shen, Tainan (TW); Yu-Chi Lee, Taipei (TW)

Correspondence Address: PERKINS COIE LLP, PATENT-SEA, P.O. BOX 1247, SEATTLE, WA, 98111-1247, US

(21) Appl. No.: 10/413,678

(22) Filed: Apr. 14, 2003

(51) Int. Cl. G02F 1/1339

(52) U.S. Cl. 349/153

(57) ABSTRACT

In conventional arts, a liquid crystal display with one drop fill (ODF) has a problem that the liquid is contaminated by a uncured sealant resulted from UV light being blocked by a black matrix, a conducting layer, etc from irradiating the sealant. In this present invention, a material of the array is replaced with a transparent material at least in a portion of an area sealant located, where the portion of area is the border between the liquid crystal and the sealant. Therefore, the sealant contacting with the liquid is completely cured by UV light without the blocking of the black matrix or the conducting layer.

### TECHNICAL FIELD

This invention relates to a peripheral structure of a liquid crystal display, and more particularly to in the border between the liquid crystal and the sealant, a wire of a liquid crystal display manufactured with one drop fill is transparent for curing the sealant with UV light.

### BACKGROUND

Due to an optical axis and a molecular axis of a liquid crystal being in concert and the liquid crystal is mobile, the molecular of the liquid crystal can be moved to form different arrangement by a slight force. For example, a common nematic type liquid crystal can be rotated with an electrical field. When light from a back light module polarized by a polarizer passes through the liquid crystal, the polarized direction of the light is changed with an arrangement direction of the liquid crystal. Different polarized directions of different lights passing through other polarizer have different transmittances. Therefore, a liquid crystal display displays different brightnesses of different display regions in response to different applied electrical fields with two polarizers and the liquid crystal. Different color can be displayed with mixing RGB (red, green and blue) colors in a same display pixel. Hence, the liquid crystal display can display a color image, even a true color image. The liquid crystal having a mobile characteristic and so the liquid crystal must be injected into a cell to fix, which the cell is composed with two glass substrates connected by a sealant. Transistors, electrodes, wire, etc. are arranged on the glass substrates to provide electrical fields for changing the arrangement direction of the liquid crystal. The aforementioned polarizers are also formed on the two glass substrates.

In those conventional arts, an injection of a liquid crystal performs with a vacuum injection: the cell composed with two glass substrates is completed and then enters a vacuum chamber. The cell has an inlet and the liquid crystal provided by a foam rubber is injected into the cell through the inlet. Due to the cell being vacuum, the air enters the chamber and then the liquid crystal enters the cell through the inlet resulting from the different atmospheric pressure between the cell and the chamber. The cell is full of the liquid crystal and the inlet is sealed to end the step of the liquid crystal injection. However, the liquid crystal injection in vacuum is too slow and the process time will increase with the size of the liquid crystal panel and the cell gap of the liquid crystal panel. Presently, the tendency of the liquid crystal display towards large size. Hence, the liquid crystal vacuum injection wastes the time cost, even increases time cost with the size of the liquid crystal panel.

Recently, a new method of liquid crystal injection is called “One-Drop Fill” (ODF). The ODF can efficiently reduce the time of the liquid crystal injection. The method of ODF uses a dropping apparatus to control the amount of liquid crystal. When the proper amount of the liquid crystal was directly dropped on the glass substrate and then the glass substrate is assembled with the other glass substrate by a sealant that was smeared on the peripheral of the glass substrate before dropping the liquid crystal. When the assembly of the glass substrates, a compressing of the sealant, and a curing step of the sealant is completed, the cell process is completed. The liquid crystal injection with the ODF reduces the step of sealing inlet and the process time is shorter than several hours. Hence, the ODF can simplify the cell process and substantially reduce the time cost.

The sequence of cell process is that before dropping liquid crystal on the peripheral of the glass substrate, smearing the sealant on the glass substrate for limiting the range of liquid crystal and assembling the cell, and then the sealant is cured with UV light. As shown in FIG. 1, a common liquid crystal panel 10 has two glass substrate of a color filter (CF) glass substrate 100 and a thin film transistor (TFT) glass substrate 120. The CF glass substrate has a color filter (not shown) and the black matrix (BM) 140 thereon. The TFT glass substrate 120 has thin film transistor (not shown), metal conducting layer 200 and so on. The BM 140 on the CF glass substrate 100 is opaque and the metal conducting layer 200 on the TFT glass substrate 120 is also opaque. Therefore, the UV light 300 and 320 are blocked regardless of passing through the CF glass substrate 100 and the TFT glass substrate 300 respectively, and so the sealant is not completely cured. When the liquid crystal 220 contacts with the uncured sealant 160, some polymers (for example, an epoxy resin) or monomers in the sealant 160 diffuses into the liquid crystal 220. The contaminated liquid crystal is driven abnormally and the liquid crystal panel will damage. For solving the abnormal driving, the UV light obliquely irradiates from a side of the cell or is reflected with a base plate for completely curing the sealant. However, the aforementioned methods are complexity and increase the irradiated danger of the liquid crystal by the UV light. The liquid crystal irradiated by the UV light not only has the problem of fission and generates the defect of arrangement resulting in decreasing the image quality, but also generates a degradation of voltage retention of the liquid crystal and so the displayed image flickers.

Hence, in those conventional arts, the problem of the ODF resulted from the uncured sealant are yet efficiently solved.

### SUMMARY

In those conventional arts, the liquid crystal panel with the ODF has the problem of the uncured sealant resulted from the UV light being blocked by the BM or the wire, and the fission problem resulted from the liquid crystal irradiated by the UV light causes the image quality decreasing. The oblique or reflected UV light solves uncured problem, but causes more liquid crystal fission. One of objectives of the present invention is to completely cure the sealant in the border between the liquid and the sealant by employing transparent wires in the border. Therefore, it is sure that the liquid crystal contacts with the cured sealant for avoiding the liquid crystal being contaminated by the uncured sealant.

Another objective of present invention is the curing sealant light that is perpendicular to the glass substrate to irradiate the sealant and so the irradiated probability of the liquid crystal is reduced for ensuring the quality of the liquid crystal.

Another objective of present invention is the curing sealant light that is perpendicular to the glass substrate to irradiate the sealant for simplifying steps of the sealant curing and the ODF.

As aforementioned, the present invention provides a structure of a liquid crystal display. The present invention replaces a material of opaque wires with a transparent material, which the wire in the border between the liquid crystal and the sealant. Therefore, the sealant curing light that passes through a TFT glass substrate is not blocked by the opaque material for ensuring the sealant in the border between the sealant and the liquid crystal being completely cured and not contaminating the liquid crystal. The present invention discloses a structure of a liquid crystal display that comprises a first glass substrate, a second glass substrate, and a sealant. A black matrix is on a surface of the first glass substrate. A thin film transistor is on a surface of the second glass substrate. The sealant smears between the first glass substrate and the second glass substrate and connects the first glass substrate and the second glass substrate to make the surface of the first glass substrate face with the surface of the second glass substrate. Wherein, an inner region of a contacting surface that the second glass substrate contacts with the sealant and near a display region of the liquid crystal display. The inner region comprises a first insulating layer, and a first conducting layer that is formed on the first insulating layer and is transparent.

The present invention also discloses a structure of a liquid crystal display that comprises a first glass substrate, a second glass substrate, and a sealant. A lack matrix is on a surface of the first glass substrate. A thin film transistor is on a surface of the second glass substrate. The sealant smears between the first glass substrate and the second glass substrate and connects the first glass substrate and the second glass substrate to make the surface of the first glass substrate face with the surface of the second glass substrate. Wherein, an region from a inner side of a connecting surface of the second glass substrate and the sealant to a edge of the liquid crystal display. The region comprises a first insulating layer and a first conducting layer that is formed on the first insulating layer and is transparent.

Hence, compared with those conventional arts, the problem of the uncured sealant and the fission problem of liquid crystal resulted from the liquid crystal irradiated by the UV light cause the image quality decreasing. The method of the oblique or reflected UV light increases the complexity of the sealant curing step and the region of the liquid crystal irradiated by the UV light. In the present invention, the sealant in the border between the liquid and the sealant is completely cured by employing transparent wires in the border for ensuring that the liquid crystal contacts the cured sealant for avoiding the liquid crystal being contaminated by the uncured sealant. Furthermore, the curing sealant light is perpendicular to the glass substrate to irradiate the sealant and so the irradiated probability of the liquid crystal is reduced for ensuring the quality of the liquid crystal. Moreover, the curing sealant light is perpendicular to the glass substrate to irradiate the sealant for simplifying steps of the sealant curing and the ODF.

### BRIEF DESCRIPTION OF THE DRAWINGS

FIG. 1 is a diagram of a peripheral structure of a liquid crystal display in the conventional arts; and

FIG. 2A and FIG. 2B are diagrams of one preferred embodiment of the present invention.

### DETAILED DESCRIPTION

Some sample embodiments of the invention will now be described in greater detail. Nevertheless, it should be recognized that present invention can be practiced in a wide range of other embodiments besides those explicitly described, and the scope of the present invention is expressly not limited expect as specified in the accompanying claims.

Then, the components of the different elements are not shown to scale. Some dimensions of the related components are exaggerated and meaningless portions are not drawn to provide a more clear description and comprehension of the present invention.

In those conventional arts, opaque structures (for example: black matrix, gate line wires, data line wires, etc.) of the liquid crystal structure manufactured with ODF block the UV light or other sealant curing light during the sealant curing step and so the sealant is not completely cured. Hence, the liquid crystal contacts with the uncured sealant and is contaminated by the uncured sealant and so the liquid crystal is driven abnormally. The essence of the present invention is that at least the portion of sealant that contacts with the liquid crystal is cured for avoiding the abnormal driving problem of the liquid crystal resulted from contaminated by the uncured sealant. Hence, the metal wire under the portion of sealant that contacts with the liquid crystal (e.g., the inner region of the sealant near the display region of the liquid crystal panel) must be transparent. Therefore, the inner region of the sealant that contacts with the liquid crystal can be enough irradiated by the sealant curing light and can be completely cured.

FIG. 2A shows one preferred embodiment of the present invention. A liquid crystal panel 10 has two glass substrates of a color filter (CF) glass substrate 100 and a thin film transistor (TFT) glass substrate 120. Color filter (not shown) and black matrix 140 are on the CF glass substrate 100. The black matrix 140 on the CF glass substrate 100 is opaque. The CF glass substrate 100 and the TFT glass substrate 120 connect with each other through a sealant 160. A insulating layer 180, conducting layers 200, 202, 204, 206, and 208 are on the TFT glass substrate 120. A material of the conducting layers 200 and 208 are preferably A1, multi-layer of A1, or alloy of A1. Conducting layers 202, 204, and 206 are transparent and the material thereof are preferably Indium Tin Oxide (ITO). For completely curing the inner region of the sealant 160, the conducting layer 206 starts from a starting position that is most near the display region (e.g. the region of the liquid crystal 220 in FIG. 2A) than the sealant 160. The starting position of the conducting layer 204 adjacent with conducting layer 206 is preferably the most inner conducting layer of the region occupied by the sealant 160 (shown in FIG. 2A). Therefore, the irradiating probability of the curing light (especially the UV light) of the liquid crystal can reduce and the quality of the liquid crystal can be maintained. According to conductivity or other considerations of the liquid crystal panel, the conducting layer 204 can end at that inside or outside of the sealant 160. The entire conducting layer 200 in FIG. 2A also can be replaced with the transparent conducting layer 204 (e.g. the conducting layer from a starting position to the edge of the glass substrate) is transparent and is formed on the insulating layer 180. For some materials of the conducting layers 202 and 204, the portion of conducting layers 202 and 204 are outside of the sealant 160 and so the material of the conducting layers 202 and 204 have the oxidized or eroded misgiving in the air. A protecting layer can be formed on the portion of conducting layers 202 and 204 outside of the sealant 160 for protecting from oxidization and erosion. The sealant curing light 320 passing through the TFT glass transistor 120 irradiates the sealant 160 and the inner region of the sealant 160 is not blocked by an opaque structure. Hence, the inner region of the sealant 160 can be completely cured for avoiding the liquid crystal 220 being contaminated by an uncured sealant.

In the process, the conducting layers 200 and 208 are simultaneously formed on the TFT glass substrate 120 through the same mask. Then, the insulating layer 180 covers the conducting layers 200 and 208 through next mask and the openings 240 and 242 are formed in the insulating layer 180. Afterward the conducting layers 202, 204 and 206 are formed through other mask. Wherein, the conducting layers 202 and 206 are formed on the openings 240 and 242, and electrically connect with the conducting layers 200 and 208 through the openings 240 and 242, respectively.

The arrangement of the conducting layer is grid (e.g., gate line wire is perpendicular to data line wire), and so the conducting layer parallel to the smearing direction of the sealant is as shown in FIG. 2A and the conducting layer perpendicular to the smearing direction of the sealant is as shown in FIG. 2B. The most outer of the conducting layer 208 must be in the region of the liquid crystal 220, preferably end at a position adjacent the common border of sealant 160 and the liquid crystal 220, as shown in FIG. 2B. The most inner of the conducting layer 200 may be in the region of the sealant 160 or in the outside of the sealant 160. The conducting layer 202 is formed on the insulating layer 180 and electrically connects with the conducting layer 200, 208 through the openings 240, 242, respectively. The conducting layer as shown in FIG. 2B also may replace with the transparent conducting layer 202 and so the conducting layer from the position adjacent the common border of sealant 160 and the liquid crystal 220 to the edge of the glass substrate is transparent and is formed on the insulating layer 180. For some materials of the conducting layers 202 have the oxidized or eroded misgiving in the air, the entire conducting layers 202 may be formed in the region of the sealant 160 or a protecting layer is formed on the portion of conducting layers 202 outside of the sealant 160 for protecting from oxidization and erosion. The sealant curing light 320 passing through the TFT glass transistor 120 irradiates the sealant 160 and the inner region of the sealant 160 is not blocked by an opaque structure. Hence, the inner region of the sealant 160 can be cured for avoiding the liquid crystal 220 being contaminated by an uncured sealant.

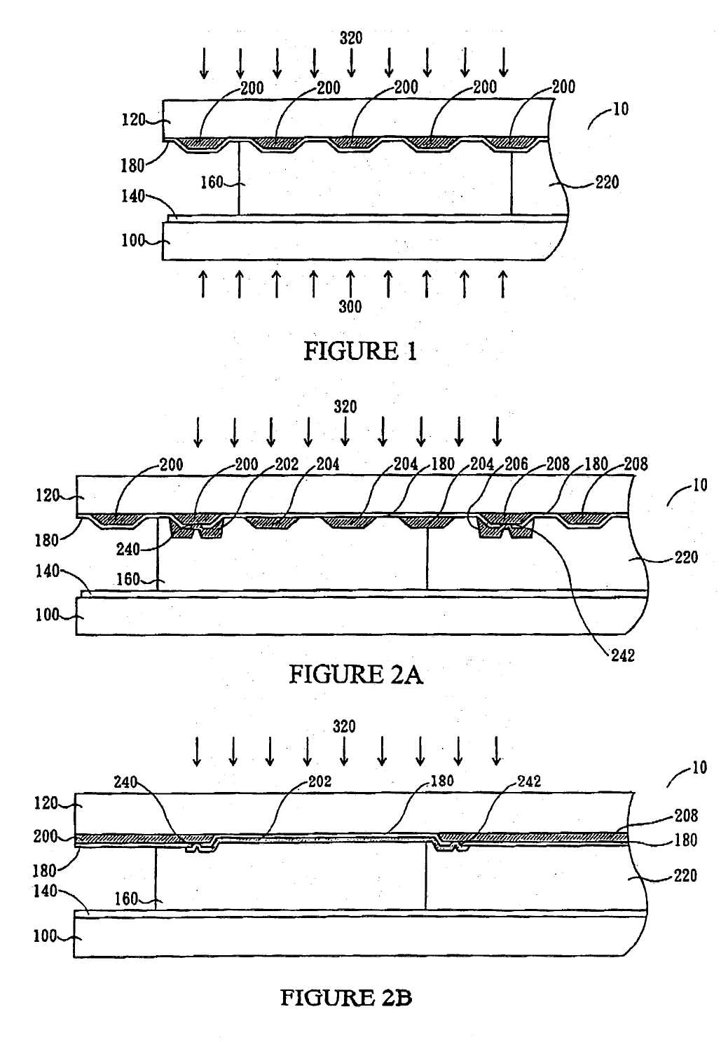

Compared with those conventional arts (as the peripheral structure of a liquid crystal display, as shown in FIG. 1), the main difference of the present invention is the structure of the conducting layer on the TFT glass substrate. According to the essence of the present invention, a portion of the sealant contacting with the liquid crystal must be completely cured for avoiding contaminating the liquid crystal. Hence, the material of the conducting layer replaces with a transparent material in the region from a starting position to an ending position. Wherein the starting position is the conducting layer (near the display region) in the most inner sealant, and the ending position is one of the conducting layer in the outer sealant, the conducting layer in the outside of sealant, or the edge of the glass substrate. The conducting layer can base on the process or design of the liquid crystal display to be formed with other structures of the liquid crystal display through the same mask. For example: the conducting layer 202, 204 and 206, as shown in FIG. 2A and a pixel electrode can be formed through the same mask. The aforementioned process of the preferred embodiment is one probable process of the present invention and does not limit the present invention to the process. Moreover, the present invention may be applied in other structures of a liquid crystal display, for example: a structure of color filter on array.

Hence, compared with those conventional arts, the problem of the uncured sealant and the fission problem of liquid crystal resulted from the liquid crystal irradiated by the UV light cause the image quality decreasing. The method of the oblique or the reflected UV light increases the complexity of the sealant curing step and the region of the liquid crystal irradiated by the UV light. In the present invention, the sealant in the border between the liquid and the sealant is completely cured by employing transparent layer in the border for ensuring that the liquid crystal contacts the cured sealant for avoiding the liquid crystal being contaminated by the uncured sealant. Furthermore, the curing sealant light is perpendicular to the glass substrate to irradiate the sealant and so the irradiated probability of the liquid crystal is reduced for ensuring the quality of the liquid crystal. Moreover, The curing sealant light is perpendicular to the glass substrate to irradiate the sealant for simplifying steps of the sealant curing and the ODF.

Although specific embodiments have been illustrated and described, it will be obvious to those skilled in the art that various modifications may be made without departing from what is intended to be limited solely by the appended claims.

I/we claim:

1. A structure of a liquid crystal display, comprising:
a first glass substrate, a black matrix on a surface of said first glass substrate;
a second glass substrate, a thin film transistor on a surface of said second glass substrate; and
a sealant, said sealant smearing between said first glass substrate and said second glass substrate and connecting said first glass substrate and said second glass substrate to make said surface of said first glass substrate connect with said surface of said second glass substrate;
wherein an inner region of a contacting surface that said second glass substrate contacts with said sealant and near a display region of said liquid crystal display, said inner region comprising:
a first insulating layer; and
a first conducting layer, said first conducting layer being formed on said first insulating layer and being transparent.

2. The structure of claim 1, wherein said structure further comprises an outer region of said contacting surface that said second glass substrate contacts with said sealant and near an edge of said liquid crystal display, said outer region comprises:
a second conducting layer; and
a second insulating conducting layer, said second insulating layer being formed on said second conducting layer;
wherein said first conducting layer electrically connecting with said second conducting layer on a overlapping region of said inner region and said outer region.

3. The structure of claim 1, wherein said first conducting layer is ITO.

4. The structure of claim 2, wherein said second conducting layer is opaque.

5. The structure of claim 2, wherein said second conducting layer is A1, multi-layer of A1, or alloy of A1.

6. The structure of claim 2, wherein said first insulating layer and said second insulating layer are formed through the same mask and connect with each other.

7. The structure of claim 2, wherein said first conducting layer and said second conducting layer are formed through different masks.

8. The structure of claim 2, wherein said overlapping region comprises:
said second conducting layer;
said second insulating layer, said second insulating layer being formed on said second conducting layer and having an opening; and
said first conducting layer, said first conducting layer being formed on said second insulating layer.

9. The structure of claim 2, wherein said first conducting layer fills said opening and electrically connects with said second conducting layer.

10. The structure of claim 2, wherein said structure further comprises a liquid crystal display region inside of said sealant, said liquid crystal display region comprises:
a third conducting layer; and
a third insulating layer, said third insulating covering said third conducting layer;
wherein said first conducting layer and third conducting layer electrically connect with each other on a overlapping region of said inner region and said liquid crystal display region.

11. The structure of claim 10, wherein said third conducting layer is opaque.

12. The structure of claim 10, wherein said third conducting layer is A1, multi-layer of A1, or alloy of A1.

13. The structure of claim 10, wherein said first insulating layer, said second insulating layer and said third insulating layer are formed through the same mask, and said second insulating layer and said third insulating layer connect with each other.

14. The structure of claim 10, wherein said second conducting layer and said third conducting layer are formed through different masks.

15. The structure of claim 10, wherein said first conducting layer and said third conducting layer are formed through the same mask.

16. The structure of claim 10, wherein said overlapping region comprises:
said third conducting layer;
said third insulating layer, said third insulating layer being formed on said third conducting layer and having an opening; and
said first conducting layer, said first conducting layer being formed on said third insulating layer.

17. The structure of claim 16, wherein said first conducting layer fills said opening and electrically connects with said third conducting layer.

18. A structure of a liquid crystal display, comprising:
a first glass substrate, a black matrix on a surface of said first glass substrate;
a second glass substrate, a thin film transistor on a surface of said second glass substrate; and
a sealant, said sealant smearing between said first glass substrate and said second glass substrate and connecting said first glass substrate and said second glass substrate to make said surface of said first glass substrate connect with said surface of said second glass substrate;
wherein an region that starts from a inner side of a connecting surface of said second glass substrate and said sealant and end at a edge of said liquid crystal display, said region comprises:
a first insulating layer; and
a first conducting layer, said first conducting layer being formed on said first insulating layer and being transparent.

19. The structure of claim 18, wherein said first conducting layer is ITO.

20. The structure of claim 18, wherein said structure further comprises a liquid crystal display region inside of said sealant, said liquid crystal display region comprises:
a second conducting layer; and
a second insulating layer, said second insulating covering said second conducting layer;
wherein said first conducting layer and second conducting layer electrically connect with each other on a overlapping region of said inner region and said liquid crystal display region.

21. The structure of claim 19, wherein said overlapping region comprises:
said second conducting layer;
said second insulating layer, said second insulating layer being formed on said second conducting layer and having an opening; and
said first conducting layer, said first conducting layer being formed on said second insulating layer.
